(19) United States
(12) Patent Application Publication
(10) Pub. No.: US 2016/0253082 A1
(43) Pub. Date: Sep. 1, 2016

(54) NUMERICAL CONTROLLER FOR CONTROLLING MACHINE TOOL

(71) Applicant: FANUC Corporation, Yamanashi (JP)

(72) Inventor: Kazuki SAKAMOTO, Yamanashi (JP)

(21) Appl. No.: 15/048,694

(22) Filed: Feb. 19, 2016

(30) Foreign Application Priority Data
Feb. 26, 2015 (JP) 2015-36758

(51) Int. Cl. G06F 3/0484; G06F 3/0488; G05B 19/19; G06F 3/0481

(52) U.S. Cl. CPC G06F 3/04847; G06F 3/04817; G06F 3/04842; G06F 3/0488; G05B 19/195; G05B 2219/34015; G05B 2219/36168; G05B 2219/32128

(57) ABSTRACT

A video image of a processing area of a machine tool is displayed as a moving image on a display screen of a numerical controller, an icon enabling an operator to intuitively recognize a direction in which a movable axis moves is displayed to overlap the moving image, an icon on the display screen corresponding to an operation of a touch panel by the operator is specified, and movement of a movable axis allocated to the specified icon is controlled.

### BACKGROUND OF THE INVENTION

1. Field of the Invention

The present invention relates to a numerical controller for controlling a machine tool, and particularly, relates to a numerical controller for operating a axis of a machine tool using a touch panel.

2. Description of the Related Art

A numerical controller is inevitably installed in a machine tool that automatically processes a workpiece. The machine tool that automatically processes the workpiece using the numerical controller essentially has a function of moving a movable axis in a manual operation by an operator. Examples of a primary operation manually performed by the operator include an initial setup operation and a tool replacement operation. These operations are important operations to enhance productivity of products manufactured using the machine tool.

To efficiently perform the initial setup operation and the tool replacement operation, the numerical controller that controls the machine tool is equipped with a means for moving the movable axis of the machine tool through a manual operation. For example, the movable axis can be moved by a manual operation using a manual pulse generator included in the numerical controller. Alternatively, the movable axis can be moved by a manual operation using a jog feed of a control panel included in the numerical controller.

The operator needs to visually check a movement amount of a axis of a processing area when moving the movable axis of the machine tool through a manual operation. If the movable axis of the processing area of the machine tool is moved without a check, even when the movable axis is erroneously moved, the erroneous movement may not be noticed at proper time. When a restriction on a movement amount of software and the like is not provided, there is a possibility that a collision of a axis (which means that a main axis collides with a workpiece, or a workpiece collides with a component of the machine tool installed in a processing area) will occur. When the collision of the axis occurs, the machine tool is greatly damaged.

For this reason, the operator needs to perform a manual operation while visually checking both the processing area of the machine tool and a screen of the numerical controller on which coordinates are displayed. However, a screen display unit of the numerical controller and the processing area may be separately installed. Thus, the operator needs to move eyes back and forth each time the operator alternately checks the screen display unit and the processing area, and the operator is greatly burdened.

A method for checking the processing area through the screen of the numerical controller is cited as an issue. Further, there is a demand for a technology for moving the movable axis using a scheme easily operated by the operator through the screen of the numerical controller.

There is a prior art (JP 2006-243875 A) for checking image data of a still image of the processing area using the screen of the numerical controller. However, the image data of the still image lacks a real-time characteristic when compared to visual observation, and cannot cope with an operation speed in an initial setup. Further, a technology disclosed in JP 2006-243875 A uses a complex detection method such as binarization processing or edge detection in image detection for a place at which an icon is displayed. For this reason, a burden is imposed on processing of the numerical controller, and a function of displaying the icon cannot be embodied by the numerical controller having poor processing capability. In addition, a possibility that the place at which the icon is displayed will be erroneously detected is considered depending on qualities of the image data.

### SUMMARY OF THE INVENTION

In this regard, an object of the invention is to provide a numerical controller which can allow a processing area to be checked in real time through a screen of the numerical controller, display an image (moving image) taken by a video camera on a screen of a display device of the numerical controller capable of operating a touch panel, display an icon such as an arrow indicating movement of a movable axis to overlap a video image, and move the movable axis according to operation of the icon.

A numerical controller of a machine tool according to the invention is a numerical controller for controlling the machine tool which has one or more movable axes. The numerical controller includes a touch panel for inputting data to the numerical controller, a display unit for displaying a moving image of a processing area of the machine tool taken by an imaging unit, a display image forming unit for forming image data for displaying an icon corresponding to each of the movable axes included in the machine tool such that the icon overlaps the moving image displayed on the display unit, a touch panel coordinate data acquisition unit for acquiring coordinate data of a position, the touch panel being operated at the position, a screen coordinate data acquisition unit for periodically acquiring coordinate data on a screen of the display unit corresponding to the coordinate data acquired by the touch panel coordinate data acquisition unit, an icon specifying unit for specifying an icon corresponding to the coordinate data on the screen among icons displayed on the display unit by the display image forming unit, and a axis movement control unit for controlling movement of a movable axis corresponding to the icon specified by the icon specifying unit.

According to a numerical controller of a machine tool of the invention, it is possible to provide a numerical controller which can allow a processing area to be checked in real time through a screen of a display device included in the numerical controller, display an image (moving image) taken by a video camera on a screen of the display device of the numerical controller capable of operating a touch panel, display an icon such as an arrow indicating movement of a movable axis to overlap a video image, and move the movable axis according to operation of the icon.

### BRIEF DESCRIPTION OF THE DRAWINGS

The above-mentioned and other objects and characteristics of the invention are clear from description of embodiments below with reference to accompanying drawings. In the drawings:

FIG. 1 is a diagram illustrating a configuration of a processing area of a machine tool and a numerical controller of an embodiment of the invention;

FIG. 2A is a diagram for description of a display of the numerical controller of FIG. 1;

FIG. 2B is a diagram for describing that a touch panel is attached to the display; and

FIG. 3 is a flowchart illustrating a procedure at the time of moving a axis.

### DETAILED DESCRIPTION OF THE PREFERRED EMBODIMENTS

The invention relates to a manual operation by an operator of a machine tool, and particularly, relates to a numerical controller having a configuration that facilitates operation of a axis by a touch panel. Hereinafter, embodiments of the invention will be described with reference to drawings.

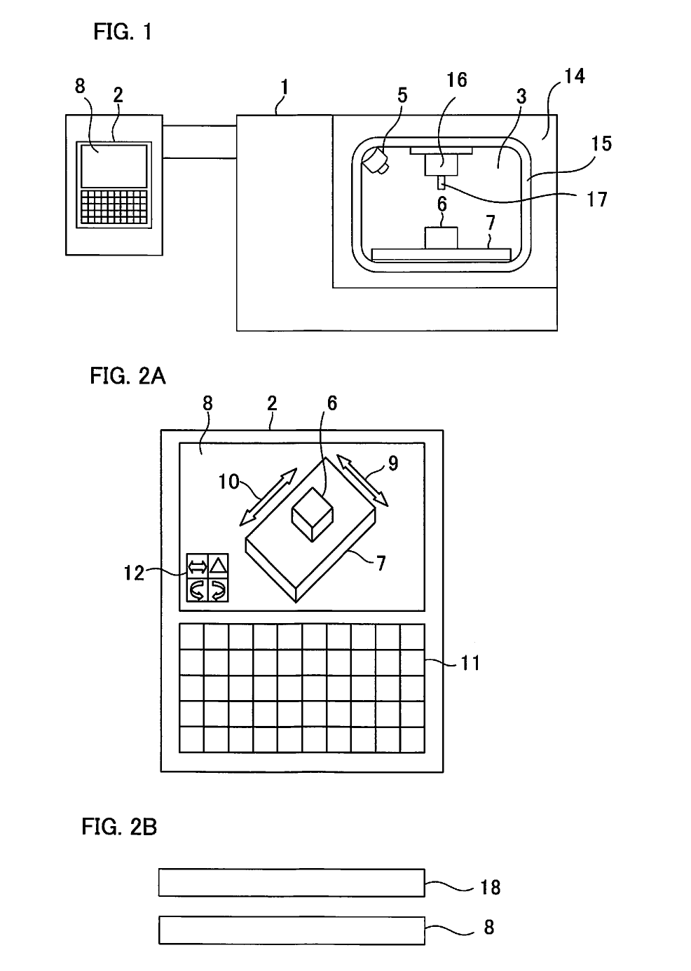

FIG. 1 is a diagram illustrating a configuration of a processing area of a machine tool and a numerical controller of an embodiment of the invention. A processing area 3 can be visually checked by an operator through a transparent window 15 provided on a cover 14. A workpiece stand 7 on which a workpiece 6 is placed and a video camera 5 that takes a moving image of the processing area 3 are arranged at predetermined positions inside the processing area 3 shielded from an outside by the cover 14.

The video camera 5 has a unit to move inside the processing area 3. Alternatively, the video camera 5 may be fixed at a predetermined position of the processing area 3. In addition, one or more video cameras 5 may be disposed inside the processing area 3. The video cameras 5 photographs a place to which a movable axis may move inside the processing area 3. A signal of a taken image is sent to a numerical controller 2, and the numerical controller 2 displays the taken image as a moving image on a screen of a display 8 (corresponding to a display unit in claims).

The machine tool 1 processes the workpiece 6 under numerical control of the numerical controller 2. The machine tool 1 processes the workpiece 6 placed on the workpiece stand 7 using a tool 17 installed on a main axis 16 in the processing area 3. The main axis 16 and the workpiece stand 7 can be relatively moved by controlling the movable axis. The movable axis is numerically controlled by the numerical controller 2 based on a processing program. In addition, the relative movement can be performed through a manual operation by the operator. Examples of a primary operation manually performed by the operator include an initial setup operation and a tool replacement operation. In the present embodiment, movement of the movable axis of the machine tool can be controlled when the operator operates a touch panel 18 (see FIG. 2B).

As illustrated in FIG. 2A, the numerical controller 2 that controls the machine tool 1 includes a processing unit, an input/output interface, and a storage device (not illustrated) similarly to a conventionally known apparatus, and includes the display 8 which performs various displays related to control of the machine tool, and an operating unit 11 such as a key switch which inputs various types of data to the numerical controller 2 and inputs an instruction to the numerical controller 2.

As illustrated in FIG. 2B, the touch panel 18, which includes a transparent electrode, is attached to the display 8. The touch panel 18 and the display 8 may use independent devices. When the operator performs an operation of pressing the touch panel 18 and the like, coordinate data of an operated position is acquired in the numerical controller 2. Coordinate data of a display screen of the display corresponding to the coordinate data acquired by operating the touch panel is acquired in the numerical controller 2.

In the present embodiment, a video image of the processing area 3 of the machine tool 1 is displayed as a moving image on the display screen of the display 8. In addition, an icon is displayed to overlap the moving image of the processing area 3 displayed on the display 8 by image processing software (corresponding to a “display image forming unit” in claims). This icon enables the operator to intuitively recognize a direction in which the movable axis moves. For example, the icon corresponds to arrows illustrated in FIG. 2A (an arrow 9 of an axis 1 and an arrow 10 of an axis 2).

As a function of the numerical controller 2, an icon table 12 in which types of arrows are recorded in advance is displayed on the screen of the display 8 of the numerical controller 2 by image processing software. The icon table 12 may be displayed at all times, and may be displayed when an icon is assigned to the movable axis.

The operator can arbitrarily select an arrow from the icon table 12 displayed on the display screen of the display 8 by operating the touch panel 18. The selected arrow is disposed at an arbitrary position on the display screen of the display 8 through a drag-and-drop operation, and the like using the touch panel 18. The arrow corresponding to the icon is preferably disposed at a position that does not hinder a screen operation. A size, a length, and an angle of the arrow can be changed by operating the touch panel 18.

An icon of an arrow disposed on the display screen of the display 8 is selected by operating the touch panel, and the movable axis to be moved is allocated thereto. Setting of a positive direction and a negative direction of the movable axis with respect to the arrow may be implemented by making shapes or sizes of arrows at both ends different from each other. For example, a great arrow is set to the positive direction, and a small arrow is set to the negative direction.

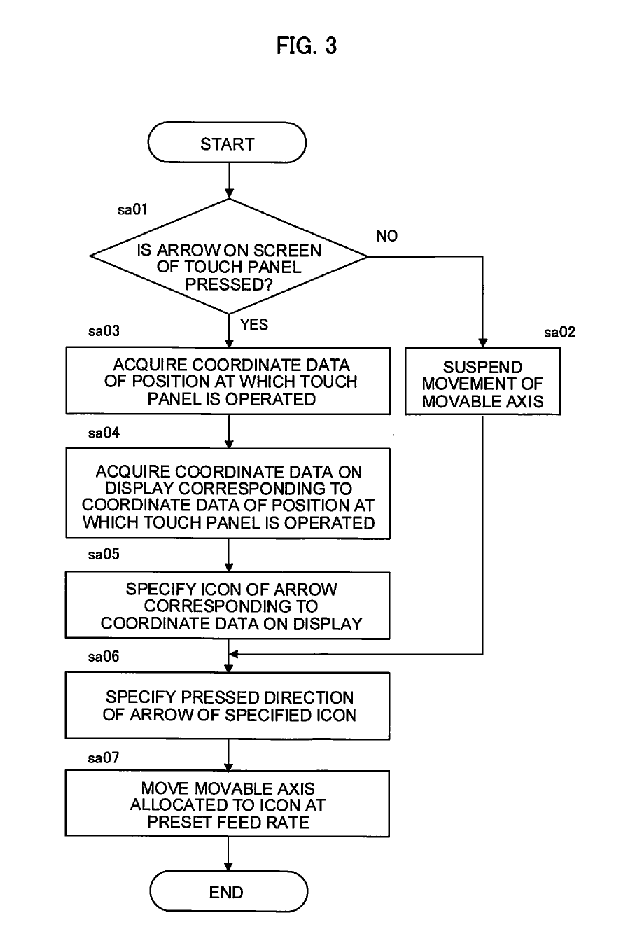

FIG. 3 is a flowchart illustrating a procedure of movement of the movable axis. A description will be given of processing of movement of the movable axis through the flowchart. A feed rate of the movable axis is set in advance. First, whether the touch panel is pressed is detected by the operator (sa01). When the fact that the touch panel is not pressed is detected, movement of the movable axis is suspended, and processing of this cycle is terminated (sa02). When the fact that the touch panel is pressed is detected, coordinate data of a position at which the touch panel is pressed is acquired (sa03). Coordinate data on the display screen corresponding to the coordinate data on the touch panel is acquired (sa04). An icon of an arrow corresponding to the acquired coordinate data on the display screen is specified (sa05). Then, a selected direction of the arrow of the specified icon is specified (sa06). The movable axis allocated to the arrow of the icon starts to be moved in the specified direction at a preset feed rate, and processing of this time is terminated (sa07).

Processing of the flowchart is periodically performed, and thus movement of the axis is continued when the screen of the touch panel is kept pressed. Movement of the axis is suspended when the touch panel is not pressed.

Processing of the flowchart will be further described. Processing of sa03 corresponds to a touch panel coordinate data acquisition unit. Processing of sa04 corresponds to a screen coordinate data acquisition unit. Processing of sa05 corresponds to an icon specifying unit. Processing of sa06 and sa07 corresponds to a axis movement control unit.

When the image of the processing area is displayed on the screen of the numerical controller, the operator needs not to move eyes back and forth between the processing area of the machine tool and the screen of the numerical controller, and thus a burden on the operator is reduced. In addition, the image is projected on the screen of the numerical controller in real time, and thus there is no need to perform screen processing of a structure from the image.

When icons of respective axes are arbitrarily displayed using software on the screen of the numerical controller on which the image of the processing area is displayed, and the icons are operated, the operator can perform an initial setup operation using only the screen of the numerical controller, and improvement in operability, which has not been achieved in the past, may be expected.

Further, when an icon is arbitrarily disposed on the screen using software, processing of a position at which the icon is displayed may not be performed using software, the numerical controller having poor processing capability may not display the icon, and erroneous detection is eliminated. In addition, a moving axis is allocated to an arrow in advance, and thus the operator may not select a axis. Further, the operator can simultaneously operate a plurality of axes by operating a plurality of arrows, and improvement in operability, which has not been achieved in the past, is obtained in the initial setup operation.

Embodiments of the invention have been described above. However, the invention is not restricted to examples of the above-described embodiments, and can be implemented in other aspects by appropriately changing the embodiments.

1. A numerical controller of a machine tool for controlling the machine tool, the machine tool having one or more movable axes, the numerical controller comprising:
a touch panel for inputting data to the numerical controller;
a display unit for displaying a moving image of a processing area of the machine tool taken by an imaging unit;
a display image forming unit for periodically forming image data for displaying an icon corresponding to each of the movable axes included in the machine tool such that the icon overlaps the moving image displayed on the display unit;
a touch panel coordinate data acquisition unit for acquiring coordinate data of a position, the touch panel being operated at the position;
a screen coordinate data acquisition unit for acquiring coordinate data on a screen of the display unit corresponding to the coordinate data acquired by the touch panel coordinate data acquisition unit;
an icon specifying unit for specifying an icon corresponding to the coordinate data on the screen among icons displayed on the display unit by the display image forming unit; and
a axis movement control unit for controlling movement of a movable axis corresponding to the icon specified by the icon specifying unit.
